(19) United States
(12) Patent Application Publication
(10) Pub. No.: US 2024/0092964 A1
(43) Pub. Date: Mar. 21, 2024

(54) IMPREGNATION RESIN FOR A WOVEN OR STITCHED FABRIC

(71) Applicant: SIKA TECHNOLOGY AG, Baar (CH)

(72) Inventors: Edis KASEMI, Zürich (CH); Ursula STADELMANN, Zürich (CH); Ulrich GERBER, Uitikon-Waldegg (CH); Christoph MAYER, Feusisberg (CH); David ELMENDORF, Ringwood, NJ (US); Amy RUSSO, Secaucus, NJ (US)

(73) Assignee: SIKA TECHNOLOGY AG, Baar (CH)

(21) Appl. No.: 17/768,078

(22) PCT Filed: Oct. 20, 2020
(86) PCT No.: PCT/EP2020/079529

§ 371 Date: Apr. 11, 2022

(30) Foreign Application Priority Data
Oct. 28, 2019 (EP) 19205597.8

(51) Int. Cl. C08G 59/50; D06M 13/332; D06M 15/55; E04G 23/02

(52) U.S. Cl. CPC C08G 59/5033; C08G 59/5006; C08G 59/504; D06M 13/332; D06M 15/55; E04G 23/0218; D06M 2101/40

(57) ABSTRACT

A method to reinforce a built structure, wherein an impregnation resin including a resin component including at least one epoxy resin and hardener component including at least one amine of the formula (I) is used to impregnate woven or stitched fabric, which is wrapped around and/or adhered onto built structure. The inventive method preferably serves to improve earthquake safety of buildings, as replacement for missing reinforcement inside concrete, for improvement of strength and ductility or for increase of payload of a built structure. It enables the application of an emission-free impregnation resin with low odour, which has a long open time and good penetration into the fabric, shows fast and reliable curing without tendency to blushing, and forms a dry, non-sticky surface. The cured impregnation resin has a high strength, a high glass transition temperature and good adhesion properties, enabling a good durability and long-term stability of the reinforced structure.

### TECHNICAL FIELD

Epoxy impregnation resin for a woven or stitched fabric, which is used for wrapping around or adhering onto a built structure for reinforcement purposes.

### STATE OF THE ART

Epoxy resin compositions curing at ambient temperatures by way of amine hardeners are widely used as impregnation resin, coating or adhesive in the building industry. An example for the use as impregnation resin is the reinforcement of built structures such as concrete pillars or bridges, wherein a woven or stitched fabric is impregnated with the impregnation resin and wrapped around and/or adhered onto the structure to be reinforced. This way of reinforcement is especially useful to upgrade built structures, for example to improve resistance against earthquakes or increased stress by structural or confinement strengthening. The impregnation resin for such an application needs to fulfill special requirements. First of all, it has to be of a low enough viscosity to be able to fully penetrate the woven or stitched fabric, with a thixotropic consistency to be workable on vertical or overhead structures without dripping or flowing down. For ecological reasons, it should be largely free from solvents and diluents to enable low emission or emission-free products. Further it needs a long open time to enable the installation on large surfaces and/or complicated geometries, together with a fast and reliable curing under ambient outdoor conditions. Further, it should be highly resistant towards blushing to provide a clean, dry and tack-free surface, allowing it to be over-coated with good interlayer adhesion. This is particularly difficult to achieve with low viscous, long open time systems, which are largely free from diluents. Blushing means the formation of salts of the amine hardener with carbon dioxide from the air, especially in cold and humid conditions. Finally, the cured impregnation resin needs to exhibit high strength and modulus, high creep resistance, high glass transition temperature (Tg), a dry, non-sticky surface and an excellent adhesion to concrete, masonry and other structural materials.

State-of-the-art epoxy adhesives are often based on amine hardeners containing adducts with epoxy resins. Such hardeners have a reduced amine odour and show an improved resistance against blushing, but their viscosity is too high for a good penetration of the woven or stitched fabric.

State-of-the-art impregnation resins are typically based on hardeners containing slow reacting specialty diamines such as 2,2(4),4-trimethyl-1,6-hexanediamine (TMD). They have a low viscosity and provide a reasonably long open time, but are rather expensive, malodourous and highly prone to blushing, especially under cold and humid outdoor conditions. To improve adhesion build-up for further layers or coatings applied thereon, the cured impregnated fabric can be rinsed with water in order to remove some of the amine salts from the surface, but this is a cumbersome and time-consuming operation without guarantee for success.

Hardeners based on alkylated amines are described for example in U.S. Pat. No. 10,301,423 or US 2019/048127. They are typically used for coating applications, particularly industrial floors, as they have a good resistance against blushing and enable coatings with high surface quality.

### SUMMARY OF THE INVENTION

The task of this invention is to provide a hardener for epoxy impregnation resins for the reinforcement of built structures with a woven or stitched fabric, which overcomes the drawbacks of state-of-the-art solutions, particularly concerning odour, fabric wetting, open time, cure speed and resistance against blushing. This task is achieved by the method according to claim 1, wherein a hardener component containing at least one amine of the formula (I) is used. The amine of the formula (I) is a monoalkylated amine with one primary and one secondary amine group. Particularly, it is a benzylated amine, preferably N-benzyl-1,2-ethanediamine.

The hardener is of low odour and low viscosity. It enables easy mixing with epoxy resins and excellent penetration through woven or stitched fabrics, particularly carbon fiber fabrics such as SikaWrap®-230 C, SikaWrap®-231 C, SikaWrap®-300 C or SikaWrap®-301 C (all from Sika), together with a long open time, a fast and reliable curing, and, after cure, a dry, non-sticky surface, a high strength, high Tg and excellent adhesion to concrete, steel, carbon fiber reinforced plastic and other structural materials.

The inventive method enables to work with emission-free and low odour impregnation resins with surprisingly good penetration qualities through the woven or stitched fabric, as well as a longer open time and faster curing and less blushing compared to state-of-the-art hardeners for this purpose based on 2,2(4),4-trimethyl-1,6-hexanediamine (TMD). The inventive hardener enables reinforced built structures, which do not need rinsing of the cured surface to remove sticky coverings caused by blushing effects to enable a good interlayer adhesion. Other aspects of the invention are described in other independent claims. Preferred aspects of the invention are described in dependent claims.

### DETAILED DESCRIPTION OF THE INVENTION

A subject of the invention is a method to reinforce a built structure, wherein an impregnation resin comprising
a resin component comprising at least one epoxy resin, and
a hardener component comprising at least one amine of the formula (I),

H₂N-A-NH—Y (1)
where
A is a divalent C₂ to C₁₅ alkylene, cycloalkylene or arylalkylene group optionally containing one or more nitrogen atoms or ether groups, and
Y is a C₁ to C₁₂ alkyl, cycloalkyl or arylalkyl group,
wherein the two nitrogen atoms, to which the group A is bound, are separated by at least two carbon atoms, and the amine of the formula (I) overall contains at least 8 carbon atoms,
is used to impregnate a woven or stitched fabric, which is wrapped around and/or adhered onto the built structure.

Substance names starting with “poly”, such as polyamine or polyepoxide, refer to substances carrying two or more of the respective functional groups per molecule. The term “primary amine group” refers to an amine group, which is connected to only one organic moiety and carries two hydrogens; the term “secondary amine group” refers to an amine group, which is connected to two organic moieties, which may also be a part of a ring, and carries one hydrogen; and the term “tertiary amine group” refers to an amine group, which is connected to three organic moieties, two or three of which may also be part of one or more rings, and carries no hydrogens.

The term “amine hydrogen” refers to the hydrogens of primary and secondary amine groups.

The term “amine hydrogen equivalent weight” refers to the mass of an amine or an amine containing composition, which contains one mol equivalent of amine hydrogens.

The term “molecular weight” refers to the molar mass (given in grams per mol) of a molecule. The term “average molecular weight” refers to the number average molecular weight Mₙ of a polydispersed mixture of oligomeric or polymeric molecules. It is usually determined by gel permeation chromatography (GPC) against a polystyrene standard.

In this document, the term “room temperature” refers to a temperature of 23° C. The term “gel time” refers to the time period between mixing a multi component composition and gelling of the composition.

The term “open time” refers to the time period after mixing a multi component composition, during which the composition is able to fully penetrate a woven or stitched fabric.

The hardener component of the impregnation resin comprises at least one amine of the formula (I).

Preferably, A is selected from the group consisting of 1,2-ethylene, 1,2-propylene, 1,3-propylene, 1,4-butylene, 1,3-butylene, 2-methyl-1,2-propylene, 1,3-pentylene, 1,5-pentylene, 2,2-dimethyl-1,3-propylene, 1,6-hexylene, 2-methyl-1,5-pentylene, 1,7-heptylene, 1,8-octylene, 2,5-dimethyl-1,6-hexylene, 1,9-nonylene, 2,2(4),4-trimethyl-1,6-hexylene, 1,10-decylene, 1,11-undecylene, 2-butyl-2-ethyl-1,5-pentylene, 1,12-dodecylene, 1,2-cyclohexylene, 1, 3-cyclohexylene, 1,4-cyclohexylene, (1,5,5-trimethylcyclohexan-1-yl)methan-1,3, 4(2)-methyl- 1,3-cyclohexylene, 1,3-cyclohexylene-bis(methylene), 1,4-cyclohexylene-bis(methylene), 1,3-phenylenebis(methylene), 1,4-phenylene-bis(methylene), 3-aza-1,5-pentylene, 3,6-diaza-1,8-octylene, 3,6,9-triaza-1, 11-undecylene, 3-aza-1.6-hexylene and 3,7-diaza-1.9-nonylene. These amines of the formula (I) are derived from commercially well available primary diamines.

Preferably, A is free of nitrogen atoms. Such amines of the formula (I) enable a particularly good resistance against blushing.

Preferably, A is a divalent C₂ to C₁₀ alkylene, cycloalkylene or arylalkylene group.

Particularly, A is selected from the group consisting of 1,2-ethylene, 1,2-propylene, 2-methyl-1,2-propylene, 1,3-pentylene, 1,2-cyclohexylene, 1,4-cyclohexylene, (1,5,5-trimethylcyclohexane-1-yl)methane-1,3, 4(2)-methyl-1,3-cyclohexylene, 1,3-cyclohexylene-bis(methylene), 1,4-cyclohexylene-bis(methylene), 1,3-phenylene-bis(methylene) and 1,4-phenylene-bis(methylene).

More preferred, A is selected from the group consisting of 1,2-ethylene, 1,2-propylene and 1,3-phenylen-bis(methylene).

Most preferred, A is 1,2-ethylene. These amines of the formula (I) are particularly low viscous, particularly cost-effective and enable a particularly fast cure at long open time.

Preferably, Y is CH₂—X, wherein X is H or a C₁ to C₁₁ alkyl, cycloalkyl, aryl or arylalkyl group. Such an amine of the formula (I) enables a particularly fast curing.

Preferably, Y is selected from the group consisting of methyl, ethyl, propyl, isopropyl, n-butyl, isobutyl, sec.butyl, n-pentyl, 3-methyl-but-2-yl, hexyl, 4-methylpent-2-yl, 2-ethylhexyl, octyl, nonyl, decyl, undecyl, dodecyl and an optionally substituted 1-phenylethyl-, 2-phenylethyl-, benzyl-, naphthylmethyl-, cyclohexylmethyl-and 2-cyclohexylethyl-moiety.

More preferably, Y has 6 to 12 carbon atoms.

Particularly, Y is selected from the group consisting of 2-ethylhexyl, 2-phenylethyl, benzyl, 1-naphthylmethyl and cyclohexylmethyl.

Most preferred, Y is benzyl. Such an amine of the formula (I) enables a particularly fast curing at low temperatures and a particularly low tendency for blushing.

The amine of the formula (I) is preferably selected from the group consisting of Nbenzyl-1,2-ethanediamine, N-(1-naphthylmethyl)-1,2-ethanediamine, N-cyclohexylmethyl-1,2-ethanediamine, N-benzyl-1,2-propanediamine, N-benzyl-bis(aminomethyl)-1,3-benzene, N-(2-ethylhexyl)-bis(aminomethyl)-1,3-benzene and N-(2-phenylethyl)-bis(aminomethyl)-1,3-benzene.

The most preferred amine of the formula (I) is N-benzyl-1,2-ethanediamine. This amine enables a particularly good combination of long open time and fast cure, together with low tendency for blushing and low odour.

The amine of the formula (I) is preferably part of a reaction mixture from the partial alkylation of at least one amine of the formula H₂N-A-NH₂ with at least one alkylating agent. The alkylation is preferably a reductive alkylation with an aldehyde or ketone, preferably with an aldehyde, and hydrogen, preferably in the presence of a suitable catalyst such as palladium on carbon (Pd/C), platinum on carbon (Pt/C), Adams-catalyst or Raney nickel, particularly palladium on carbon or Raney nickel. The reductive alkylation with molecular hydrogen is preferably done at a hydrogen pressure of 5 to 150 bar, preferably 10 to 100 bar, either in a batch process or in a continuous process, at a temperature in the range of 40 to 120° C., preferably 60 to 100° C.

If the amine of the formula H₂N-A-NH₂ is a small volatile amine such as 1,2-ethanediamine or 1,2-propanediamine, the amine is preferably used in a stoichiometric excess towards the aldehyde or ketone, followed by removing the excess amine, at least partially, from the reaction mixture after hydrogenation, preferably by a distillation process.

Optionally, the reaction mixture is further purified, particularly by overhead distillation of the monoalkylated amine of the formula (I), during which it is at least partially freed from the corresponding dialkylated amine.

Preferably, the inventive hardener component contains a limited amount of dialkylated amines of the formula A(NH—Y)₂. Preferably, the weight ratio between monoalkylated amines of the formula (I) and dialkylated amines of the formula A(NH—Y)₂ is in the range of 70/30 to 100/0, more preferably 80/20 to 100/0. Such a low amount of dialkylated amine enables a fast curing and is technically easy available.

In a preferred embodiment of the invention, the hardener component is largely free from dialkylated amines of the formula A(NH—Y)₂. Preferably, the purity of the amine of the formula (I) ist more than 95 weight-%. Such a hardener enables particularly fast curing.

In another preferred embodiment of the invention, the hardener component contains amines of the formula (I) and dialkylated amines of the formula A(NH—Y)₂ in a weight ratio in the range of 70/30 to 95/5, preferably 80/20 to 95/5. Such a hardener is particularly well accessible and particularly cost-effective.

A preferred hardener component contains a mixture of N-benzyl-1,2-ethanediamine and N,N′-dibenzyl-1,2-ethanediamine in a weight ratio in the range of 70/30 to 95/5, preferably 80/20 to 95/5.

In a preferred embodiment of the invention, the hardener component further contains at least one amine with at least two primary amine groups.

Suitable amines with at least two primary amine groups are aliphatic, cycloaliphatic or arylaliphatic polyamines, particularly 2,2-dimethyl-1,3-propanediamine, 1,3-pentanediamine (DAMP), 1,5-pentanediamine, 1,5-diamino-2-methylpentane (MPMD), 2-butyl-2-ethyl-1,5-pentanediamine (C₁₁-neodiamine), 1,6-hexanediamine, 2,5-dimethyl-1,6-hexanediamine, 2,2(4),4-trimethyl-1,6-hexanediamine (TMD), 1,7-heptanediamine, 1,8-octanediamine, 1,9-nonanediamine, 1,10-decanediamine, 1,11-undecanediamine, 1,12-dodecanediamine, 1,2-, 1,3- or 1,4-diaminocyclohexane, 1,3-bis(aminomethyl)cyclohexane, 1,4-bis(aminomethyl)cyclohexane, bis(4-aminocyclohexyl)methane, bis(4-amino-3-methylcyclohexyl)methane, bis(4-amino-3-ethylcyclohexyl)methane, bis(4-amino-3,5-dimethylcyclohexyl)methane, bis(4-amino-3-ethyl-5-methylcyclohexyl)methane, 1-amino-3-aminomethyl-3,5,5-trimethylcyclohexane (isophoronediamine or IPDA), 2(4)methyl-1,3-diaminocyclohexane, 2,5(2,6)-bis(aminomethyl)bicyclo[2.2.1]heptane (NBDA), 3(4),8(9)-bis(aminomethyl)tricyclo[5.2.1.0^{2,6}]decane, 1,4-diamino-2,2,6-trimethylcyclohexane (TMCDA), 1,8-menthanediamine, 3,9-bis(3-aminopropyl)2,4,8,10-tetraoxaspiro[5.5]undecane, 1,3-bis(aminomethyl)benzene (MXDA), 1,4-bis(aminomethyl)benzene, bis(2-aminoethyl)ether, 3,6-dioxaoctan-1,8-diamine, 4,7-dioxadecan-1,10-diamine, 4,7-dioxadecane-2,9-diamine, 4,9-dioxadodecane1,12-diamine, 5,8-dioxadodecane-3,10-diamine, 4,7,10-trioxatridecane-1,13-diamine or higher oligomers of these diamines, bis(3-aminopropyl)polytetrahydrofurane or other polytetrahydrofuranediamines, polyoxyalkylene polyamines, particularly Jeffamine® D-230, Jeffamine® D-400, Jeffamine® D-2000, Jeffamine® EDR-104, Jeffamine® EDR-148, Jeffamine® EDR-176, Jeffamine® T-403, Jeffamine® T-3000 or Jeffamine® T-5000 (all from Huntsman), bis(6-aminohexyl)amine (BHMT), diethylenetriamine (DETA), triethylenetetramine (TETA), tetraethylenepentamine (TEPA), pentaethylenehexamine (PEHA) or higher homologues thereof, dipropylenetriamine (DPTA), N-(2-aminoethyl)-1,3-propanediamine (N3-Amine), N,N′-bis(3-aminopropyl)ethylenediamine (N4-amine), N,N′-bis(3-aminopropyl)-1,4-diaminobutane, N5-(3-aminopropyl)-2-methyl-1,5-pentanediamine, N3-(3-aminopentyl)-1,3-pentanediamine, N5-(3-amino-1-ethylpropyl)-2-methyl-1,5-pentanediamine or N,N′-bis(3-amino-1-ethylpropyl)-2-methyl-i1,5-pentanediamine.

Preferred amines are selected from the group consisting of TMD, 1,2- diaminocyclohexane, 1,4-diaminocyclohexane, 1,3-bis(aminomethyl)cyclohexane, 1,4-bis(aminomethyl)cyclohexane, bis(4-aminocyclohexyl)methane, IPDA, 2(4)-methyl-1,3-diaminocyclohexane, NBDA, MXDA, 1,4-bis(aminomethyl)benzene, polyoxyalkylene polyamines, TETA, TEPA, PEHA, N4-amine and mixtures thereof.

Preferred thereof is IPDA, 2(4)-methyl-1,3-diaminocyclohexane, NBDA, polyoxyalkylene polyamines, TETA, TEPA, PEHA or N4-amine.

In a preferred embodiment of the invention, the hardener component contains at least one polyoxypropylene polyamine with an average molecular weight Mₙ in the range of 200 to 500 g/mol, such as Jeffamine® D-230, Jeffamine® D-400 or Jeffamine® T-403 (all from Huntsman). Preferably the weight ratio between the amine of the formula (I) and polyoxypropylene polyamines in the hardener is in the range of 50/50 to 99/1, preferably 60/40 to 90/10. Such amounts of polyoxypropylene polyamine can help to achieve a particularly long open time at still fast curing.

In another preferred embodiment of the invention, the hardener contains at least one polyalkylene polyamine, particularly selected from TETA, TEPA, PEHA and N4-amine, preferably in a minor amount.

Preferably the weight ratio in the hardener between the amine of the formula (I) and the polyalkylene polyamine is in the range of 70/30 to 99/1, preferably 80/20 to 95/5. Such minor amounts of polyalkylene polyamine can help to achieve a faster curing with still low tendency for blushing.

The resin component of the inventive impregnation resin comprises at least one epoxy resin.

The epoxy resin is preferably a liquid epoxy resin or a mixture of two or more liquid epoxy resins.

The term “liquid epoxy resin” means a technical grade of a polyepoxide with a glass transition temperature of below 25° C.

Optionally, a resin component comprising at least one liquid epoxy resin may further contain minor amounts of a solid epoxy resin.

Particularly suitable epoxy resins are aromatic epoxy resins, particularly glycidylization products of
bisphenol A, bisphenol F or bisphenol A/F;
resorcinol, hydroquinone or catechol;
further bisphenols or polyphenols such as bis(4-hydroxy-3-methylphenyl)methane, 2,2-bis(4-hydroxy-3-methylphenyl)propane (bisphenol C), bis(3,5-dimethyl-4-hydroxyphenyl)methane, 2,2-bis(3,5-dimethyl-4-hydroxyphenyl)propane, 2,2-bis(3,5-dibromo-4-hydroxyphenyl)propane, 2,2-bis(4-hydroxy-3-tert.butylphenyl)propane, 2,2-bis(4-hydroxyphenyl)butane (bisphenol B), 3,3-bis(4-hydroxyphenyl)pentane, 3,4-bis(4-hydroxyphenyl)hexane, 4,4-bis(4-hydroxyphenyl)heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol Z), 1,1-bis(4-hydroxyphenyl)-3,3,5-trimethylcyclohexane (bisphenol TMC), 1,1-bis(4-hydroxyphenyl)-1-phenylethane, 1,4-bis[2-(4-hydroxyphenyl)-2-propyl]-benzene (bisphenol P), 1,3-bis[2-(4-hydroxyphenyl)-2-propyl]benzene (bisphenol M), 4,4′-dihydroxydiphenyl (DOD), 4,4′-dihydroxybenzophenone, bis(2-hydroxynaphth-1-yl)methane, bis(4-hydroxynaphth-1-yl)methane, 1,5-dihydroxynaphthalene, tris(4-hydroxyphenyl)methane, 1,1,2,2-tetrakis(4-hydroxyphenyl)ethane, bis(4-hydroxyphenyl)ether or bis(4-hydroxyphenyl)sulfone;
novolaks, which are preferably products of the condensation of phenols or cresols with formaldehyde, paraformaldehyde, acetaldehyde, crotonaldehyde, isobutyraldehyde, 2-ethylhexanal, benzaldehyde or furfuraldehyde;
aromatic amines such as aniline, toluidine, 4-aminophenol, 4,4′-methylenediphenyldiamine, 4,4′-methylenediphenyldi-(N-methyl)amine, 4,4′-[1,4-phenylenbis(1-methylethyliden)]bisaniline (bisaniline P) or 4,4′-[1,3-phenylen-bis(1-methylethyliden)]bisaniline (bisaniline M).

Suitable liquid epoxy resins are further aliphatic or cycloaliphatic polyepoxides, particularly
glycidyl ethers of di-, tri- or tetrafunctional C₂- to C₃₀-alcohols, particularly ethylene glycol, propylene glycol, butylene glycol, hexanediol, octanediol, polypropylene glycols, dimethylolcyclohexane, neopentyl glycol, dibromoneopentyl glycol, castor oil, trimethylolpropane, trimethylolethane, pentaerythritol, sorbitol or glycerol, or alkoxylated glycerol or alkoxylated trimethylolpropane;
a hydrogenated bisphenol A, F or A/F liquid resin, or the glycidylization product of a hydrogenated bisphenol A, F or A/F;
a N-glycidyl derivate of an amide or a heterocyclic nitrogen base, such as triglycidyl cyanurate or triglycidyl isocyanurate, or reaction products of epichlorohydrin with hydantoin;
epoxy resins from the oxidation of olefins, such as vinylcylohexene, dicyclopentadiene, cyclohexadiene, cyclododecadiene, cyclododecatriene, isoprene, 1,5-hexadiene, butadiene, polybutadiene or divinylbenzene.

The epoxy resin of the resin component is preferably an aromatic liquid epoxy resin based on a bisphenol. Particularly it is a technical grade of a bisphenol A, F or A/F diglycidyl ether. These resins are low viscous and enable fast curing and high hardness.

Optionally the resin component contains minor amounts of a solid bisphenol A resin or novolak glycidyl ethers.

Preferably, the resin component contains at least one liquid resin based on bisphenol A diglycidyl ether, bisphenol F diglycidyl ether or bisphenol A/F diglycidyl ether.

Preferably the resin component further contains at least one reactive diluent, particularly an epoxy functional reactive diluent, particularly selected from the group consisting of butandiol diglycidyl ether, neopentylglycol diglycidyl ether, hexandiol diglycidyl ether, cyclohexanedimethanol diglycidyl ether, trimethylolpropane di- or triglycidyl ether, phenyl glycidyl ether, cresyl glycidyl ether, guaiacol glycidyl ether, 4-methoxyphenyl glycidyl ether, p-n-butylphenyl glycidyl ether, ptert.butylphenyl glycidyl ether, 4-nonylphenyl glycidyl ether, 4-dodecylphenyl glycidyl ether, cardanol glycidyl ether, benzyl glycidyl ether, allyl glycidyl ether, butyl glycidyl ether, hexyl glycidyl ether, 2-ethylhexyl glycidyl ether and glycidyl ethers of natural alcohols such as C₈ to C₁₀ alcohols, C₁₂ to C₁₄ alcohols and C₁₃ to C₁₅ alcohols.

Preferred thereof is butandiol diglycidyl ether, neopentylglycol diglycidyl ether, hexandiol diglycidyl ether, p-tert.butylphenyl glycidyl ether, a C₁₂ to C₁₄-or C₁₃ to C₁₅ alkyl glycidyl ether, or mixtures thereof.

The inventive impregnation resin may contain further ingredients. Such further ingredients are part of the resin component or part of the hardener component or of both the resin and the hardener component, or they can be used in the form of a further, separate component.

Preferably, the inventive impregnation resin contains at least one filler. Particularly suitable fillers are calcium carbonates, optionally surface-treated with a fatty acid, barites, talc, quartz flour, quartz sand, silicon carbide, iron mica, dolomites, wollastonites, kaolins, mica, molecular sieves, aluminium oxides, aluminium hydroxides, magnesium hydroxide, silicas, cement, gypsum, fly ashes, carbon black, graphite, metal powders, PVC powder or hollow spheres, and/or pigments such as titanium dioxide or iron oxides.

A preferred filler is calcium carbonate, particularly a surface-treated precipitated calcium carbonate. A surface-treated precipitated calcium carbonate enables a thixotropic consistency at still low viscosity.

The impregnation resin preferably contains fillers in the range of 10 to 60 weight-%, particularly 20 to 50 weight-%, based on the total impregnation resin.

Preferably, both the resin component and the hardener component contain an amount of these fillers.

Preferably, the resin component contains fillers in the range of 10 to 60 weight-%, particularly 20 to 50 weight-%, based on the total resin component.

Preferably, the hardener component contains fillers in the range of 10 to 60 weight-%, particularly 20 to 50 weight-%, based on the total hardener component.

The inventive impregnation resin may further contain at least one diluent. Particularly suitable diluents are xylene, 2-methoxyethanol, dimethoxyethanol, 2-ethoxyethanol, 2-propoxyethanol, 2-isopropoxyethanol, 2-butoxyethanol, 2-phenoxyethanol, 2-benzyloxyethanol, benzyl alcohol, ethylene glycol, ethylene glycol dimethyl ether, ethylene glycol diethyl ether, ethylene glycol dibutyl ether, ethylene glycol diphenyl ether, diethylene glycol, diethylene glycol monomethyl ether, diethylene glycol monoethyl ether, diethylene glycol mono-n-butyl ether, diethylene glycol dimethyl ether, diethylene glycol diethyl ether, diethylene glycol di-n-butyl ether, propylene glycol butyl ether, propylene glycol phenyl ether, dipropylene glycol, dipropylene glycol monomethyl ether, dipropylene glycol dimethyl ether, dipropylene glycol di-n-butyl ether, diphenylmethane, diisopropylnaphthalene, petroleum fractions such as Solvesso® grades (from Exxon), cardanol (from cashew nutshell oil, containing as main constituent 3-(8,11-pentadecadienyl)phenol), styrenated phenol, bisphenols, aromatic hydrocarbon resins, particularly those containing phenol groups, alkoxylated phenols, particularly ethoxylated or propoxylated phenols, particularly 2-phenoxyethanol, adipates, sebacates, phthalates, benzoates, organic phosphoric or sulfonic acid esters or sulfonamides.

Preferred are diluents with a boiling point of more than 200° C.

Particularly preferred is a diluent selected from the group consisting of benzyl alcohol, ethoxylated phenol, diisopropylnaphthalene and cardanol.

Preferably, the impregnation resin contains only small amounts of diluents or is largely free from diluents. Preferably, it contains less than 10 weight-%, more preferably less than 5 weight-%, particularly less than 1 weight-%, of nonreactive diluents.

The inventive impregnation resin may further contain at least one accelerator. Particularly suitable accelerators are acids or compounds which can be hydrolyzed to acids, more particularly organic carboxylic acids such as acetic acid, benzoic acid, salicylic acid, 2-nitrobenzoic acid or lactic acid, organic sulfonic acids such as methanesulfonic acid, p-toluenesulfonic acid or 4-dodecylbenzene sulfonic acid, sulfonic esters such as methyl p-toluene sulfonate, or phosphoric acids; nitrates such as calcium nitrate; tertiary amines such as 1,4-diazabicyclo[2.2.2]octane, benzyldimethylamine, a-methylbenzyldimethylamine, triethanolamine, dimethylaminopropylamine, imidazoles such as N-methylimidazole, N-vinylimidazole or 1,2-dimethylimidazole, salts of such tertiary amines, quaternary ammonium salts such as benzyltrimethylammonium chloride, amidines such as 1,8-diazabicyclo[5.4.0]undec-7-ene, guanidines such as 1,1,3,3-tetramethylguanidine, phenolic resins or Mannich bases such as 2-(dimethylaminomethyl)phenol or particularly 2,4,6-tris(dimethylaminomethyl)phenol, or polymers from phenol, formaldehyde and N,N-dimethyl-1,3-propanediamine, phosphites such as diphenyl or triphenyl phosphite, or compounds containing mercapto groups.

Preferred accelerators are selected from salicylic acid, p-toluenesulfonic acid, methyl p-toluene sulfonate, calcium nitrate, 2,4,6-tris(dimethylaminomethyl)phenol, and combinations thereof.

The inventive impregnation resin may contain further additives, particularly further reactive diluents such as epoxidized soybean oil, epoxidized linseed oil, acetoacetylated polyols, butyrolactone, carbonates, aldehydes, isocyanates or silicones with reactive groups, solvents, further amines, substances with mercapto groups, polymers, fumed silica, hollow glass spheres, rheology modifiers, adhesion promoters such as organoalkoxysilanes, flame retarders, surfactants, stabilizers against oxidation, heat, light or UV-radiation, or a biocide.

In the impregnation resin, the ratio of the number of groups that are reactive towards epoxy groups, mainly amine hydrogens, to the number of epoxy groups is preferably in the range of 0.5 to 1.5, particularly 0.7 to 1.2.

The amine hydrogens react with epoxy groups present in the composition with ring opening of the latter (addition reaction). As a result of mainly this reaction the impregnation resin undergoes polymerization and therefore cures.

The resin component and the hardener component of the impregnation resin are each stored in their own containers. Further ingredients can be part of the resin component or of the hardener component, whereas ingredients which are reactive towards amines are part of the resin component and ingredients which are reactive towards epoxides are part of the hardener component.

A suitable container for storing the resin component or the hardener component is particularly a drum, a Hobbock, a pouch, a bucket, a pail, a canister, a cartridge or a tube.

Each component is stable upon storage. This means it can be kept for several months up to a year or more before use without suffering alteration in its properties to any extent relevant for its use.

For the use of the impregnation resin, the resin component, the hardener component and, if present, further components are mixed with each other shortly before or during the application. The mixing ratio is preferably selected such that the amine hydrogens and the epoxy groups are in an appropriate ratio to each other, as given before. In terms of parts by weight, the mixing ratio between the resin component and the hardener component is customarily in the range from 1:10 to 10:1. Typically, it is in the range of 1:1 to 10:1. The components are mixed with each other by means of a suitable method. Mixing takes place preferably at ambient or slightly elevated temperatures, particularly in the range from 5 to 40° C., preferably 10 to 30° C. Curing of the epoxy resin composition starts by chemical reaction upon mixing of the components, as described above. Curing typically takes place at ambient temperatures, preferably in the range of 5 to 40° C. The time to cure is dependent on factors including temperature, reactivity of the reactive ingredients and their stoichiometry and the presence of accelerators. The impregnation resin is preferably applied onto the built structure and the woven or stitched fabric is pressed into it within the open time of the impregnation resin. It is also possible to first impregnate the woven or stitched fabric with the impregnation resin followed by contacting the impregnated fabric with the built structure.

After mixing, the impregnation resin has preferably a low viscous, thixotropic consistency, in order to allow an application on vertical or overhead structures without flowing down or dripping away and still allowing an easy penetration through the pressed in woven or stitched fabric.

Ten minutes after mixing the components, the impregnation resin preferably has a viscosity, determined at 25° C. by a cone/plate rheometer in the range of 1 to 20 Pa-s, preferably 2 to 12 Pa-s.

The application of the impregnation resin onto the built structure is preferably done by a roller, a spatula, a trowel, a brush or a paintbrush. It is also possible to use spray application.

Preferably, the impregnation resin is applied in a layer thickness of 0.1 to 2 mm, particularly 0.2 to 1.2 mm, depending on the surface of the built structure and on the thickness of the woven or stitched fabric, through which it is supposed to penetrate.

The woven or stitched fabric, which is used together with the impregnation resin, can be any flat woven or stitched fabric with a porous structure, through which the applied impregnation resin can penetrate. To achieve a good reinforcement of the built structure, the woven or stitched fabric is preferably of a material with high tear resistance and toughness.

Preferably, the woven or stitched fabric is made mainly from carbon fibers. Preferably, the woven or stitched fabric contains at least 50 weight-%, more preferably at least 75 weight-%, particularly at least 90 weight-%, carbon fibers, based on the total weight of the fabric. It may contain other materials, particularly selected from polyester, thermoplastic polymers, glass fibers, epoxy powder and mixtures thereof.

Preferably, the woven or stitched fabric is an unidirectional woven carbon fiber fabric, possibly containing up to 10 weight-% of other materials.

It is also possible to use a glass fibre fabric, such as SikaWrap®-430 G (from Sika).

Preferably the woven or stitched fabric has an area density in the range of 100 to 1,000 g/m², preferably 150 to 600 g/m², particularly 200 to 400 g/m².

Preferably the woven or stitched fabric has a thickness in the range of 0.1 to 0.5 mm, particularly 0.1 to 0.3 mm.

Preferably, the woven or stitched fabric is provided in the form of a roll with a width in the range of 100 to 1′000 mm, typically 300 or 600 mm. A typical length of such a roll is 50 m. Such woven or stitched fabrics are commercially available, preferably as SikaWrap®-230 C, SikaWrap®-231 C, SikaWrap®-300 C or SikaWrap®-301 C (all from Sika).

For the use to reinforce the built structure, the woven or stitched fabric may be cut into a suitable size, for example with scissors, a knife or a saw.

The woven or stitched fabric is typically contacted with and pressed into the applied impregnation resin within the open time of the impregnation resin, so that the impregnation resin penetrates through the fabric. The pressing into the applied impregnation resin is preferably done by hands equipped with suitable gloves, or by a roller, a spatula, a brush or any other tool, or a combination thereof.

After the pressing of the fabric into the applied impregnation resin, the impregnation resin is allowed to cure.

It can be beneficial to apply a further layer of the impregnation resin, followed by pressing another layer of woven or stitched fabric into it, depending on the desired degree of reinforcement of the built structure.

It is possible to cover the reinforced structure with a paint or a coating.

If the cured impregnation resin is being overcoated, it is highly beneficial if the surface of the cured impregnation resin is dry, non-sticky and free from any coverings of salts formed by blushing phenomena, to allow a good interlayer adhesion without any time-consuming pretreatments such as rinsing, washing or cleaning of the surface or treating it with a primer or adhesion promotor.

It is also possible to apply a layer of sand onto the still wet impregnation resin to end up with a rough, sandy surface.

The built structure, which is reinforced by the inventive method, is preferably part of a supporting structure. The reinforcement is preferably done by shear strengthening and/or confinement strengthening.

A preferred built structure is selected from the group consisting of a wall, a pillar, a column, a support, a beam, a ceiling, a stair, a balcony, a chimney, a roof and a bridge.

The built structure is typically of a material selected from natural stone, brickwork, concrete, steel reinforced concrete, mortar and wood.

The surface of the built structure can be specially prepared before the impregnation resin is applied, particularly by grinding and/or by the application of a primer.

The inventive method to reinforce a built structure preferably comprises the steps of
(i) mixing the components of the impregnation resin,
(ii) application of the mixed impregnation resin onto the built structure,
(iii) contacting the woven or stitched fabric with the applied impregnation resin,
(iv) pressing the fabric into the impregnation resin within the open time of the impregnation resin, so that the impregnation resin penetrates through the fabric,
followed by the curing of the impregnation resin.

The steps (i) to (iv) can be repeated to apply one or more further layers of impregnated woven or stitched fabric onto the already applied layer to achieve an enhanced reinforcement.

It is also possible to impregnate the woven or stitched fabric with the impregnation resin before it is contacted with the built structure. This is preferably done by placing the woven or stitched fabric in a bath filled with impregnation resin or by passing it through a roller whereby the fabric is contacted with the impregnation resin. The impregnated fabric is then wrapped around or adhered onto the built structure. This way of application is preferred for woven or stitched fabrics of high density and a high area weight, particularly of 400 g/m² or more, such as SikaWrap®-530 C, SikaWrap®-600 C or SikaWrap®-900 C (all from Sika).

The inventive method to reinforce a built structure preferably serves to improve the earthquake safety of buildings, as a replacement for a missing reinforcement inside the concrete, for improvement of the strength and ductility of pillars, columns, supports or beams, or for the increase of the payload of a bridge, a floor/ceiling, a roof, a stair or a balcony. A reinforcement is mainly achieved in terms of confinement strengthening or structural strengthening.

Another subject of the invention is an article containing a reinforced built structure obtained by the inventive method, as described.

This article is preferably a building, a bridge, a gallery, or a part of it, particularly a chimney, a ceiling, a wall, a pillar, a column, a beam, a support, a balcony, a terrace, a staircase or a roof.

The inventive method enables the application of an impregnation resin with low odour and/or no or low emission of organic volatiles, with a long open time and a low viscosity, facilitating the application of the woven or stitched fabric in the described way, showing a fast and reliable curing without a tendency to blush at cold and humid outdoor conditions, and forming a dry, non-sticky surface. This enables the application of another layer of impregnation resin or any other coating without interlayer adhesion problems. The cured impregnation resin has a high strength, a high Tg and good adhesion properties, enabling good durability and long-term stability of the reinforced structure.

Preferred is an impregnation resin comprising an epoxy resin and a hardener containing at least one amine of the formula (I),

H₂N-A-NH—Y (I)
where
A is a divalent C₂ to C₁₅ alkylene, cycloalkylene or arylalkylene group optionally containing one or more nitrogen atoms or ether groups, and
Y is a C₁ to C₁₂ alkyl, cycloalkyl or arylalkyl group,
wherein the two nitrogen atoms, to which the group A is bound, are separated by at least two carbon atoms, and the amine of the formula (I) overall contains at least 8 carbon atoms,
   for the impregnation of a woven or stitched fabric, which is wrapped around and/or adhered onto a built structure for reinforcement purposes, as described before.

The most preferred amine of the formula (I) therefore is N-benzyl-1,2-ethanediamine.

### EXAMPLES

The following examples illustrate the present invention without being limiting.
“AHEW” means amine hydrogen equivalent weight.
“EEW” means epoxy group equivalent weight.
“Normal climate” means a temperature of 23±1° C. and a relative atmospheric moisture of 50±5%.
Chemical substances not otherwise specified are from Sigma-Aldrich Chemie GmbH.

The amine number was determined by titration (with 0.1_{N} HCIO₄ in acetic acid against crystal violet).

Used substances:

| | |
|---|---|
| Araldite ® GY 250: | bisphenol A diglycidyl ether, EEW 188 g/mol, |
| | from Huntsman |
| Araldite ® DY-E: | monoglycidyl ether of C₁₂ to C₁₄ alcohols, |
| | EEW 290 g/mol, from Huntsman |
| Erisys ® GE-20: | neopentylglycol diglycidyl ether, EEW 135 |
| | g/mol, from Emerald Performance Materials |
| B-EDA crude: | mixture of N-benzyl-1,2-ethanediamine |
| | and N,N′-di-benzyl-1,2-ethanediamine, |
| | prepared as described below, AHEW 57 g/eq |
| B-EDA pure: | N-benzyl-1,2-ethanediamine, prepared as |
| | described below, AHEW 50.1 g/eq |
| Jeffamine ® D-230: | polyoxypropylene diamine, average |
| | molecular weight Mₙ 230 g/mol, AHEW |
| | 60 g/mol, from Huntsman |
| TETA: | triethylenetetramine, technical grade, AHEW |
| | 28 g/mol, from Huntsman |
| TMD: | Vestamin ® TMD, 2,2(4),4-trimethyl-1,6- |
| | hexanediamine, AHEW 39.6 g/mol, |
| | from Evonik |
| 1,3-BAC: | 1,3-bis(aminomethyl)cyclohexane, AHEW |
| | 35.5 g/mol, from Mitsubishi Gas Chem. |
| Socal ® U1S2: | surface-treated precipitated calcium |
| | carbonate filler, from Solvay |

Preparation of Amines of the Formula (I):

B-EDA crude: Reaction mixture containing N-benzyl-1,2-ethanediamine 180.3 g (3 mol) of 1,2-ethanediamine were placed in a round bottom flask under a nitrogen atmosphere at room temperature. A solution of 106.0 g (1 mol) benzaldehyde in 1200 ml of isopropanol was added dropwise under good stirring, followed by another 30 minutes of stirring. Then, the reaction mixture was subjected to hydrogenation on a continuous hydrogenation apparatus with Pd/C fixed-bed catalyst under a hydrogen pressure of 80 bar at a temperature of 80° C. with a flow rate of 5 ml/min. The resulting solution was concentrated on a rotary evaporator under reduced pressure at 65° C., with removal of unreacted 1,2-ethanediamine, water and isopropanol.

The reaction mixture thus obtained was a clear, slightly yellowish liquid with an amine number of 686 mg KOH/g, containing, as determined by gas chromatography, 81 weight-% N-benzyl-1,2-ethanediamine (retention time 8.47-8.57 min) and 17.6 weight-% N,N′-dibenzyl-1,2-ethanediamine (retention time 14.27 min).

B-EDA Pure: Purified N-Benzyl-1,2-Ethanediamine

The reaction mixture obtained above, named B-EDA crude, was purified by over head distillation under reduced pressure. The product was collected at a vapor temperature of 60 to 65° C. under 0.06 bar. It was a colorless liquid having an amine number of 750 mg KOH/g and a purity in relation to N-benzyl-1,2-ethanediamine as determined by gas chromatography of >97 weight-%.

Preparation of Impregnation Resins:

Compositions C-1 to C-6:

There was prepared a Resin Component for each composition by mixing 56 weight parts (wp) Araldite® GY-250, 10 wp Erisys® GE-20, 4 wp Araldite® DY-E and 30 wp Socal® U1 S2, followed by storing it in a closed container. There was further prepared a Hardener Component for each composition by mixing the ingredients given in Table 1, followed by storing it in a closed container. The resin component and the hardener component were mixed in the proportion (in weight parts) given in Table 1 (mixing ratio) in a centrifugal mixer (SpeedMixer™ DAC 150, FlackTek Inc.) for 15 sec at 1500 rpm followed by 15 sec at 2000 rpm.

The freshly mixed impregnation resins were then tested as follows:

The viscosity was measured 10 minutes, 60 minutes and then every 30 minutes after mixing the components (total amount 150 g) on a thermostated cone/plate rheometer Rheotec RC30 (cone diameter 25 mm, cone angle 1°, cone tip/plate distance 0.05 mm, shear rate 10 s₋₁) at a temperature of 25° C., until the material was gelled.

The gel time was determined with a freshly mixed portion of 150 g by keeping it in a plastic beaker with a diameter of 100 mm and checking the consistency with a spatula until the material was gelled.

The open time was determined by applying a portion of about 50 g of the freshly mixed material onto a concrete surface in a layer thickness of about 1.5 mm. One hour after the application, a strip of SikaWrap®-231 C (unidirectional woven carbon fiber fabric, from Sika) (50×100 mm) was placed onto the applied material and worked into it by a roller, thereby checking, if the applied material was able to completely penetrate the SikaWrap®-231 C tissue. This procedure was repeated from time to time on a not yet covered area, until the impregnation resin could no longer penetrate the SikaWrap®-231 C tissue properly, i.e. the open time was over.

Shore D hardness was determined according to DIN 53505 with cylindrical samples of 20 mm diameter and a thickness of 5 mm. One sample was stored in normal climate with determination of its hardness after 1 day (1d NC) and after 2 days (2d NC). Another sample was stored in a chamber with 8° C. and 80% relative humidity with determination of its hardness after 1, 2 and 7 days in cold state, (1d 8°/80%), (2d 8°/80%) or (7d 8°/80%).

The Surface Aspect was judged at the samples which were used for the determination of the Shore D hardness. One sample was stored 1 day in normal climate (1d NC), the other sample was stored 7 days at 8° C./80% relative humidity and then 1 day in normal climate (7d 8°/80%+1d NC). “dry” means, the surface was dry and non-sticky, “(sticky)” means, the surface was slightly sticky, and “sticky” means, the surface was distinctly sticky.

Tensile Strength, Elongation (at break) and E-Modulus 0.25% (from 0.05 to 0.25% elongation) were determined according to EN ISO 527 at a crosshead speed of 1 mm/min up to an elongation of 0.5% and then 10 mm/min up to the break of the sample. The samples were prepared by applying the mixed impregnation resin into silicone molds to get dumbbell shaped samples with a length of 150 mm and a thickness of 10 mm, at a bridge length of 80 mm and a bridge width of 10 mm. Some samples were tested after a cure time of 1 day at normal climate (1d NC), other samples were tested after a cure time of 7 days at normal climate (7d NC).

The lap shear strength (LSS steel) was determined according to DIN EN 1465 with a crosshead speed of 10 mm/min. The samples were prepared by applying the mixed impregnation resin between two steel sheets cleaned with acetone at a thickness of 0.5 mm in an overlapping adhesion area of 10×25 mm and a cure time of 7 days at normal climate.

The Tg (glass transition temperature) value was determined by differential scanning calorimetry (DSC) with the cured impregnation resin after a curing time of 14 days at normal climate, with a Mettler Toledo DSC 3+700 apparatus and the following procedure (1) −10° C. during 2 min, (2) −10 to 200° C. with a heating rate of 10 K/min (=1st run), (3) 200 to −10° C. with a cooling rate of −50 K/min, (4) −10° C. during 2 min, (5) −10 to 180° C. with a heating rate of 10 K/min (=2nd run).

The test results are given in Table 1.

Compositions with “(Ref.)” are non-inventive impregnation resins for comparison.

TABLE 1
Composition and properties of C-1 to C-6.

| | | | | C-4 | C-5 | C-6 |
|---|---|---|---|---|---|---|
| Composition | C-1 | C-2 | C-3 | (Ref.) | (Ref.) | (Ref.) |
| Hardener Component: | | | | | | |
| B-EDA pure | 60.0 | — | 50.0 | — | — | — |
| B-EDA crude | — | 60.0 | — | — | — | — |
| Jeffamine ® D-230 | — | — | 10.0 | 40.0 | — | — |
| TETA | — | — | — | 20.0 | — | — |
| TMD | — | — | — | — | 60.0 | — |
| 1,3-BAC | — | — | — | — | — | 60.0 |
| Socal ® U1S2 | 40.0 | 40.0 | 40.0 | 40.0 | 40.0 | 40.0 |
| Mixing Ratio¹ (weight) | 100/32 | 100/36.5 | 100/33 | 100/32 | 100/25 | 100/23 |
| Viscosity [Pa · s] 10 min | 8.3 | 7.2 | 8.3 | 8.1 | 7.9 | 8.2 |
| 60 min | 12.1 | 10.3 | 13.7 | 12.1 | 30.9 | 27.1 |
| 90 min | 25.6 | 20.0 | 57.4 | 16.8 | gelled | gelled |
| 120 min | gelled | 25.3 | 86.5 | 35.8 | | |
| 150 min | | 229.9 | gelled | 113.4 | | |
| 180 min | | gelled | | gelled | | |
| Gel Time [h:min] | 1:45 | 2:40 | 2:10 | 2:45 | 1:20 | 1:20 |
| Open Time [h:min] | 1:40 | 2:15 | 1:45 | 2:30 | 1:10 | 1:10 |
| Shore D (1d NC) | 75 | 76 | 77 | 50 | 75 | 75 |
| (2d NC) | 77 | 78 | 79 | 50 | 76 | 77 |
| Shore D (1d 8°/80%) | 42 | 10 | 17 | soft | 63 | 64 |
| (2d 8°/80%) | 64 | 61 | 66 | 48 | 69 | 71 |
| (7d 8°/80%) | 69 | 65 | 72 | 70 | 69 | 75 |
| Surface Aspect | | | | | | |
| (1d NC) | dry | dry | dry | (sticky) | sticky | sticky |
| (7d 8°/80% + 1d NC) | dry | dry | dry | (sticky) | sticky | sticky |
| 1d NC: | | | | | | |
| Tensile Strength [MPa] | 12.3 | 12.7 | 16.7 | 5.2 | 18.4 | |
| Elongation [%] | 0.7 | 0.9 | 1.0 | 34 | 0.9 | n.d. |
| E-Modulus 0.25% [MPa] | 1940 | 1560 | 1730 | 110 | 2280 | |
| 7d NC: | | | | | | |
| Tensile Strength [MPa] | 15.7 | 17.0 | 21.7 | 14.6 | 21.3 | |
| Elongation [%] | 0.5 | 0.6 | 0.7 | 0.6 | 0.8 | n.d. |
| E-Modulus 0.25% [MPa] | 3350 | 3240 | 3560 | 2813 | 3220 | |
| LSS steel [MPa] | 8.9 | 13.5 | 14.8 | 15.6 | 6.9 | n.d. |
| Tg (first/second run) [° C.] | 46/61 | 48/58 | 47/61 | 49/73 | 45/75 | 56/99 |

″n.d.″ means ″not determined″
¹Resin Component to Hardener Component

Use of the impregnation resins to reinforce a built structure:

A cylindrical concrete object, which is called “pillar” in the following text, with a diameter of 300 mm and a height of 500 mm, was provided for each composition. A portion of about 2 kg of each Composition C-1, C-2 or C-3, as described before, was mixed by a drilling machine with a stirring rod. Within 30 minutes after mixing, each composition was applied onto the surface around the pillar by a roller in an amount of about 1.2 kg/m² (approx. 1 mm).

After a waiting time of 30 min, a layer of SikaWrap®-231 C (unidirectional woven carbon fiber fabric, from Sika) with a width of 300 mm and a length of 1 m was placed onto the applied composition by wrapping it around the pillar, so that the center of the pillar was covered with a ring of the fabric at a height of 300 mm, followed by pressing the fabric into the applied, uncured composition by a roller, so that the composition penetrated through the fabric over its whole area. After a curing time of 24 hours in normal climate, the surface of each reinforced pillar with the impregnated fabric was checked. The reinforced pillars each showed a hard, non-sticky, dry and glossy surface.

Then, onto each pillar, another portion of the same freshly mixed Composition C 1, C-2 or C-3, respectively, was applied in an amount of about 0.5 kg/m² onto the cured impregnated fabric by a roller, followed by another layer of SikaWrap®-231 C pressed into it, as described before. After a curing time of 24 hours at normal climate, the adhesion of the second layer of the impregnated fabric on the first layer was checked by cutting through the layers and trying to separate them from each other with a knife. Each pillar showed an excellent adhesion between the two layers.

1. A method to reinforce a built structure, wherein an impregnation resin comprising
a resin component comprising at least one epoxy resin, and
a hardener component comprising at least one amine of the formula (I),
H₂N-A-NH—Y (I)
where
A is a divalent C₂ to C₁₅ alkylene, cycloalkylene or arylalkylene group optionally containing one or more nitrogen atoms or ether groups, and
Y is a C₁ to C₁₂ alkyl, cycloalkyl or arylalkyl group,
wherein the two nitrogen atoms, to which the group A is bound, are separated by at least two carbon atoms, and the amine of the formula (I) overall contains at least 8 carbon atoms,
is used to impregnate a woven or stitched fabric, which is wrapped around and/or adhered onto the built structure.

2. The method according to claim 1, wherein A is selected from the group consisting of 1,2-ethylene, 1,2-propylene, 2-methyl-1,2-propylene, 1,3-pentylene, 1,2-cyclohexylene, 1,4-cyclohexylene, (1,5,5-trimethylcyclohexane-1-yl)methane-1,3, 4(2)-methyl-1,3-cyclohexylene, 1,3-cyclohexylene-bis(methylene), 1,4-cyclohexylene-bis(methylene), 1,3-phenylene-bis(methylene) and 1,4-phenylenebis(methylene).

3. The method according to claim 1, wherein Y is CH₂—X.

4. The method according to claim 1, wherein Y is selected from the group consisting of 2-ethylhexyl, 2-phenylethyl, benzyl, 1-naphthylmethyl and cyclohexylmethyl.

5. The method according to claim 1, wherein the amine of the formula (I) is selected from the group consisting of Nbenzyl-1,2-ethanediamine, N-(1-naphthylmethyl)-1,2-ethanediamine, N-cyclohexylmethyl1,2-ethanediamine, N-benzyl-1,2-propanediamine, N-benzyl-bis(aminomethyl)-1,3-benzene, N-(2-ethylhexyl)-bis(aminomethyl)-1,3-benzene and N-(2-phenylethyl)-bis(aminomethyl)1,3-benzene.

6. The method according to claim 1, wherein the amine of the formula (I) is N-benzyl-1,2-ethanediamine.

7. The method according to claim 1, wherein the hardener component contains a mixture of N-benzyl-1,2-ethanediamine and N,N′-dibenzyl-1,2-ethanediamine in a weight ratio in the range of 70/30 to 95/5.

8. The method according claim 1, wherein the hardener component further contains at least one amine with at least two primary amine groups.

9. The method according to claim 8, wherein the further amine is at least one polyoxypropylene polyamine with an average molecular weight Mₙ in the range of 200 to 500 g/mol.

10. The method according to claim 1, wherein the resin component contains at least one liquid resin based on bisphenol A diglycidyl ether, bisphenol F diglycidyl ether or bisphenol A/F diglycidyl ether.

11. The method according to claim 1, wherein the impregnation resin contains at least one filler.

12. The method according to claim 1, wherein the woven or stitched fabric contains at least 50 weight-% carbon fibers, based on the total weight of the fabric.

13. The method according to claim 1, wherein the built structure is selected from the group consisting of a wall, a pillar, a column, a support, a beam, a ceiling, a stair, a balcony, a chimney, a roof and a bridge.

14. The method according to claim 1, comprising the steps of
(i) mixing the components of the impregnation resin,
(ii) application of the mixed impregnation resin onto the built structure,
(iii) contacting the woven or stitched fabric with the applied impregnation resin,
(iv) pressing the fabric into the impregnation resin within the open time of the impregnation resin, so that the impregnation resin penetrates through the fabric, followed by the curing of the impregnation resin.

15. An article containing a reinforced built structure obtained by the method according to claim 1.
